(19) United States
(12) Patent Application Publication
(10) Pub. No.: US 2023/0306401 A1
(43) Pub. Date: Sep. 28, 2023

(54) REGISTRATION DEVICE AND METHOD

(71) Applicant: TOSHIBA TEC KABUSHIKI KAISHA, Tokyo (JP)

(72) Inventor: Nobuaki SUGIURA, Tagata Shizuoka (JP)

(21) Appl. No.: 17/949,160

(22) Filed: Sep. 20, 2022

(30) Foreign Application Priority Data
Mar. 23, 2022 (JP) 2022-046951

(51) Int. Cl. G06Q 20/20; G06Q 20/18; G06K 7/10

(52) U.S. Cl. CPC G06Q 20/208; G06Q 20/18; G06Q 20/202; G06K 7/10366

(57) ABSTRACT

A commodity registration device in a POS system including a self-service payment device for payment processing, includes a scanner configured to read commodity information from a code attached to a commodity, a tag reader configured to read tag information from a wireless tag attached to a container for storing commodities, a communication interface configured to communicate with the payment device or a server that can communicate with the payment device, and a processor configured to control the reader to read tag information from a wireless tag attached to a container, upon receipt of commodity information by the scanner, store the commodity information in association with the tag information, and control the communication interface to transmit, to the payment device or the server, the commodity information and the tag information so that the payment device can associate the second commodity information with the first or second tag information.

### CROSS-REFERENCE TO RELATED APPLICATION(S)

This application is based on and claims the benefit of priority from Japanese patent application No. 2022-046951, filed Mar. 23, 2022, the entire contents of which are incorporated herein by reference.

### FIELD

Embodiments described herein relate generally to a registration device, a payment device, and a method performed by a point of sale (POS) system.

### BACKGROUND

Conventionally, there is a POS system adopting semi-self-service checkout in which a store clerk operates a registration device to register commodities for a customer, and then the customer operates a payment device to pay for the commodities. To complete the transaction, the customer needs to operate the payment device via a touch screen to access the payment information issued by the registration device in association with the registered commodities. However, it takes time for a customer who is not used to such semi-self-service checkout to complete payment, causing congestion at the payment device.

### BRIEF DESCRIPTION OF THE DRAWINGS

FIG. 1 is a block diagram showing a POS system according to a first embodiment.

FIG. 2 is a schematic diagram showing a commodity registration device according to a first embodiment.

FIG. 3 is a schematic diagram showing a payment device according to a first embodiment.

FIG. 4 is a hardware block diagram showing a commodity registration device according to a first embodiment.

FIG. 5 is a hardware block diagram showing a payment device according to a first embodiment.

FIG. 6 is a hardware block diagram showing a server according to a first embodiment.

FIG. 7 is a flowchart of processing performed by a commodity registration device according to a first embodiment.

FIG. 8 is a flowchart of processing performed by a payment device according to a first embodiment.

FIG. 9 is a flowchart of processing performed by a server according to a first embodiment.

FIG. 10 is a flowchart of processing performed by a commodity registration device according to a second embodiment.

FIG. 11 is a flowchart of processing performed by a payment device according to a second embodiment.

FIGS. 12 and 13 are flowcharts of processing performed by a commodity registration device according to a third embodiment.

FIG. 14 is a flowchart of processing performed by a server according to a third embodiment.

### DETAILED DESCRIPTION

Embodiments provide a registration device and a method that allow customers to smoothly proceed to payment processing.

A commodity registration device according to one embodiment is in a point of sale (POS) system including a self-service payment device configured to perform payment processing on registered commodities. The registration device includes a scanner configured to read commodity information from a code attached to a commodity, a wireless tag reader configured to read tag information from a wireless tag attached to a container for storing commodities, a communication interface configured to communicate with the payment device or a server that can communicate with the payment device, and a processor. The processor is configured to: control the tag reader to read first tag information from a first wireless tag attached to a first container, upon receipt of first commodity information by the scanner, store in a memory the first commodity information in association with the first tag information, and control the communication interface to transmit, to the payment device or the server, the first commodity information and the first tag information so that the payment device can associate the second commodity information with the first or second tag information.

Hereinafter, a registration device, a payment device, a commodity sales data processing server, and a commodity sales data processing method according to one or more embodiments will be described with reference to the drawings. Before the detailed description of the embodiments, shopping baskets used therein will be described. Each of the shopping baskets has a radio-frequency identification (RFID) tag attached thereto. An RFID tag radiates electromagnetic waves through its antenna to transmit and receive information to and from other devices. In each RFID tag, a unique number for identifying a shopping basket to which the RFID tag is attached is stored as tag information. Although a shopping basket will be described as an example of a container for storing one or more commodities in this disclosure, any container capable of storing one or more commodities such as a bag may be used. Also, tag information stored in an RFID tag may be a unique number for identifying a customer or store member or the like.

### First Embodiment

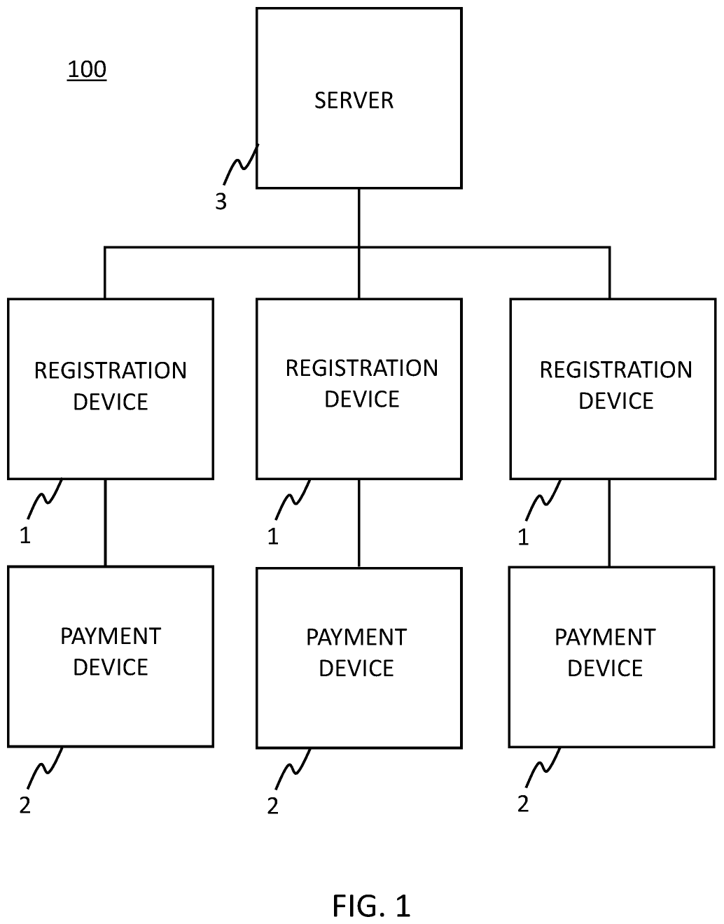

FIG. 1 is a block diagram showing a POS system 100 according to a first embodiment. The POS system 100 includes a commodity registration device 1, a payment device 2, and a server 3. The commodity registration device 1 is connected to the payment device 2 and the server 3 through a bus or a wired/wireless network. The payment device 2 is connected to the commodity registration device 1 through a bus or a wired/wireless network. The server 3 is connected to the commodity registration device 1 through a bus or a wired/wireless network. The commodity registration device 1, the payment device 2, and the server 3 may communicate with each other via a wired/wireless network.

The commodity registration device 1 registers commodity information. The commodity registration device 1 acquires and registers commodity information indicating a commodity purchased by a customer. The commodity information in this embodiment includes a commodity name, a price, and the like. The commodity registration device 1 further acquires tag information from an RFID tag attached to a shopping basket storing the purchased commodity. The commodity registration device 1 transmits to the server 3 the acquired commodity information in association with the acquired tag information.

The payment device 2 performs payment processing based on a total amount obtained by summing up the prices of commodities acquired by the commodity registration device 1 from the commodity information. When the payment device 2 acquires tag information from an RFID tag attached to a shopping basket, the payment device 2 requests the server 3 to transmit the commodity information associated with the tag information by the commodity registration device 1.

The server 3 performs processing relating to the commodity information transmitted from the commodity registration device 1. The server 3 stores commodity information associated with tag information.

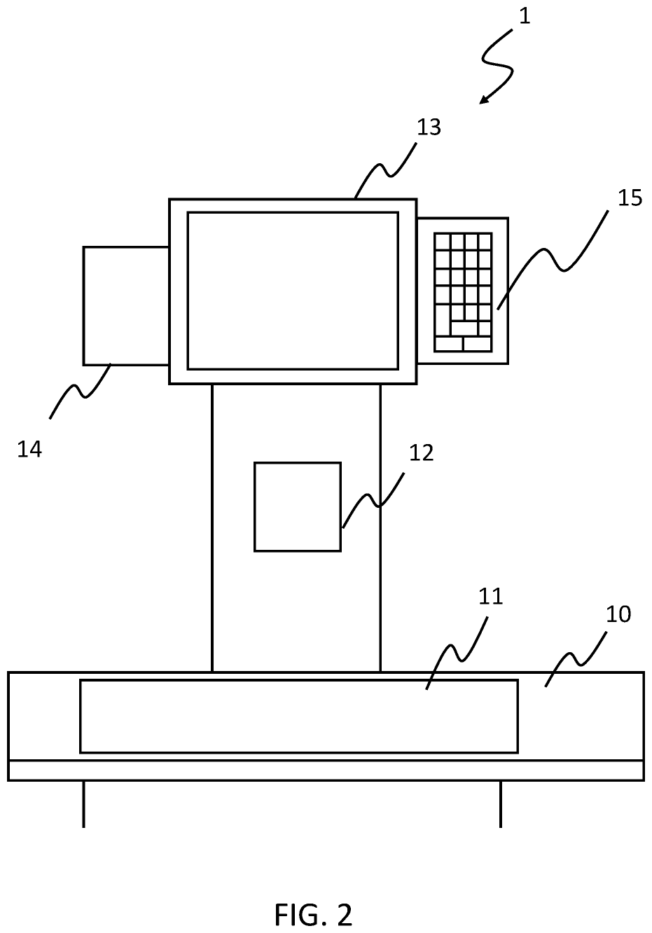

FIG. 2 is a schematic diagram showing the commodity registration device 1. The commodity registration device 1 includes a table 10, a tag reader 11, a commodity reader 12, a clerk-side display device 13, a customer-side display device 14, and input keys 15.

On the table 10, commodities and one or more shopping baskets are placed. For example, the table 10 is used for a store clerk to move purchased commodities in a shopping basket into another shopping basket or the like when the commodity registration device 1 performs a registration operation on the purchased commodities by reading the commodity information.

The tag reader 11 has an antenna and acquires tag information from an RFID tag. The tag reader 11 acquires tag information by emitting an electromagnetic wave to wirelessly communicate with an RFID tag. The tag reader 11 is stored in a housing having a flat plate shape, and is embedded in the mounting surface of the table 10.

The commodity reader 12 acquires commodity information from a commodity code attached to a commodity or the like. The commodity reader 12 is a scanner which optically reads such a commodity code to acquire commodity information. A commodity code attached to a commodity or the like indicates a price of the commodity and a commodity name. A commodity code is a code symbol such as a one dimensional code (e.g., a bar code) or a two dimensional code (e.g., a QR code).

Although the commodity reader 12 is described as a scanner in this embodiment, the commodity reader 12 may be a tag reader having an antenna for acquiring tag information from an RFID tag attached to a commodity. Similarly to the tag reader 11, the commodity reader device 12 may acquire tag information (i.e., commodity information) by emitting an electromagnetic wave to wirelessly communicate with an RFID tag attached to a commodity. The tag reader device 11 and the commodity reader device 12 may be the same device.

The clerk-side display device 13 and the customer-side display device 14 display information relating to the commodity registration device 1. The clerk-side display device 13 and the customer-side display device 14 are display devices such as liquid crystal displays (LCD) and organic EL displays. The clerk-side display device 13 displays information for a store clerk who operates the commodity registration device 1. For example, the clerk-side display device 13 displays commodity information read by the commodity reader 12. Further, when the clerk-side display device 13 includes a touch panel, the clerk-side display device 13 can display an area for inputting an instruction for proceeding from registration processing to payment processing or an area for adding a preset amount to a total amount may be displayed. The customer-side display device 14 displays information about registered commodities for a customer. The customer-side display device 14 displays, for example, a commodity name and a price of each purchased commodities, a total price thereof, and the like.

The input keys 15 accept various inputs of instructions from a store clerk for operating the commodity registration device 1. The input keys 15 include a keypad for calculation, a preset key for adding a preset amount to the total amount of purchased commodities, and a subtotal key for proceeding from commodity registration to payment processing.

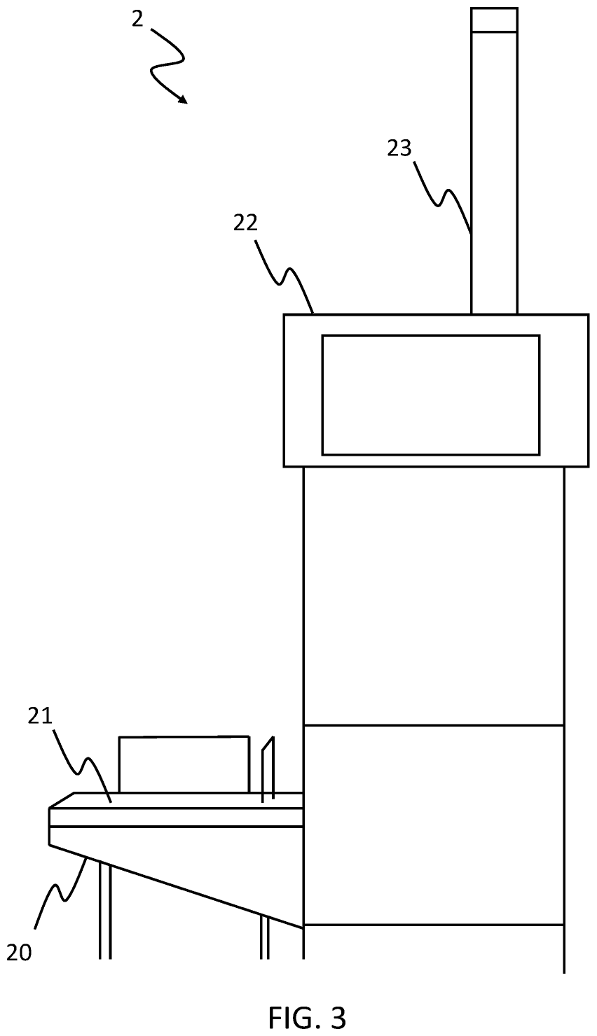

FIG. 3 is a schematic diagram showing the payment device 2. The payment device 2 includes a table 20, a tag reader 21, a display device 22, and a notification device 23.

On the table 20, a shopping basket that stores registered commodities is placed. In the table 20, the tag reader 21 for reading tag information from an RFID tag attached to the shopping basket is installed.

The tag reader 21 has an antenna through which tag information is received from an RFID tag. The tag reader 21 acquires tag information by emitting an electromagnetic wave via the antenna to wirelessly communicate with an RFID tag. Further, the tag reader 21 is stored in a housing having a flat plate shape, and is embedded in the mounting surface of the table 20.

The display device 22 displays information relating to the payment device 2. The display device 22 is an LCD or an organic EL display device. The display device 22 displays, for example, a screen relating to payment by electronic money or credit card in addition to the commodity information read by the commodity registration device 1. When the display device 22 includes a touch panel, the display device 22 can display an area for inputting an instruction for proceeding to payment processing or an area for selecting a payment method. Further, the display device 22 displays, for example, a commodity name of each registered commodity, a total amount thereof, a balance of electronic money of a customer, and the like.

The notification device 23 notifies the state of the payment device 2. The notification device 23 has a lamp or the like. The notification device 23 notifies a clerk by lighting a lamp when an error or a defect at the time of payment, or when cash, a payment medium (e.g., a credit card), or a receipt is not normally dispensed. For example, the notification device 23 may notify the state by switching colors of lights emitted by the lamp.

In addition to the above components, the payment device 2 has a payment medium reading device, a change machine, a receipt printer, a receipt discharge port and the like (not shown). The payment medium reading device reads a payment medium such as a credit card and acquires user information from the read medium. In the change machine, insertion slots for inserting bills and coins are arranged outside the payment device 2, and the inserted bills or coins are stored in the change machine. The receipt printer prints receipts and coupons.

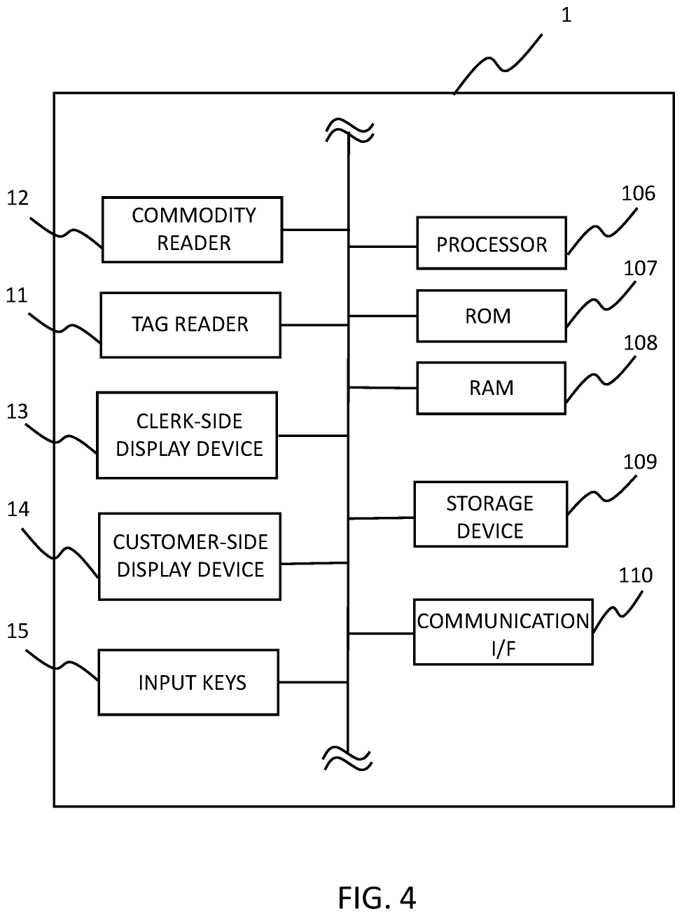

FIG. 4 is a hardware block diagram showing the commodity registration device 1. The commodity registration device 1 includes the commodity reader 12, the tag reader 11, the clerk-side display device 13, the customer-side display device 14, the input keys 15, a processor 106, a read only memory (ROM) 107, a random access memory (RAM) 108, a storage device 109, and a communication interface (I/F) 110, and those components are connected to each other through a bus.

As described above with reference to FIG. 2, the commodity reader 12 optically reads a commodity code attached to a commodity or the like. The article code is a code symbol such as a one dimensional code such as a bar code or a two dimensional code. The commodity reader 12 decodes the read code symbol and acquires a commodity code indicated by the code symbol to acquire commodity information. The decoding of the code symbol may be performed by the processor 106. The commodity reader 12 may be a camera that images a commodity and identifies the commodity by object recognition based on the characteristic amount of the imaged commodity such as color or unevenness.

The tag reader 11 acquires tag information from an RFID tag attached to a shopping basket.

The clerk-side display device 13 displays commodity information read by the commodity reader 12 as well as the total amount calculated by the processor 106 and images related to registration processing.

Similarly, the customer-side display device 14 displays commodity information read by the commodity reader 12, information related to registration processing, and the like. The customer-side display device 14 may display an electronic money balance if information about a customer's electronic money account is input in the registration processing.

The input keys 15 can be used for a store clerk to input some preset instructions or data.

For example, the processor 106 is a central processing unit (CPU) that controls the entire operations of the commodity registration device 1. The ROM 107 stores various programs executed by the processor 106 and various data. The RAM 108 is used as a work area by the processor 106 to load various software programs and various data stored in the ROM 107 and the storage device 109. Examples of the data loaded in the RAM 108 include commodity information acquired by the commodity reader 12 and tag information acquired by the tag reader 11. The processor 106 executes various functional processes of the commodity registration device 1 in accordance with the programs stored in the storage device 109 and/or the ROM 107 and loaded into the RAM 108. The processor 106 associates the commodity information acquired by the commodity reader 12 with the tag information acquired by the tag reader 11. The processor 106 controls the communication I/F 110 to transmit the tag information associated with the commodity information to the server 3.

For example, the storage device 109 is a hard disk drive (HDD) or a flash memory. The storage device 109 stores an operating system for operating the commodity registration device 1, software such as other necessary application programs, and user information. The storage device 109 may also store the commodity information and tag information associated with the commodity information.

The communication I/F 110 is an interface circuit for transmitting and receiving information to and from an external device such as the payment device 2 and the server 3. The information transmitted by the communication I/F 110 is, for example, commodity information acquired by the commodity reader 12 and tag information associated with the commodity information. Further, the communication I/F 110 receives a request from the payment device 2 for confirming whether the tag information is associated with the commodity information, and transmits the request to the server 3.

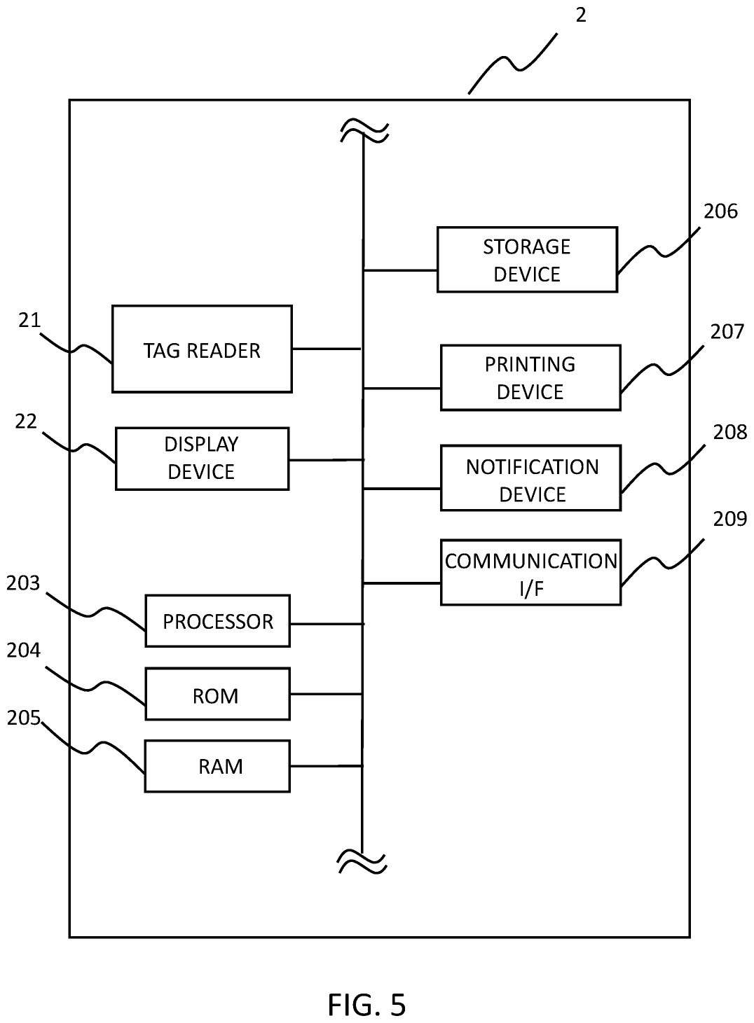

FIG. 5 is a hardware block diagram showing the payment device 2. The payment device 2 includes the tag reader 21, the display device 22, a processor 203, a ROM 204, a RAM 205, a storage device 206, a printing device 207, a notification device 208, and a communication I/F 209, and each component is connected through a bus.

The tag reader 21 reads tag information from an RFID tag attached to a shopping basket.

The display device 22 displays the commodity information and the electronic money balance received from the server 3, as well as the total amount calculated by the processor 106 and images related to payment processing.

For example, the processor 203 is a CPU that controls the entire operations of the payment device 2. The ROM 204 stores various programs executed by the processor 203, and various data. The RAM 205 is used as a work area by the processor 203 to load various software programs and various data stored in the ROM 204 and the storage device 206. Examples of the data loaded into the RAM 205 include tag information acquired by the tag reader 21 and commodity information associated with the tag information and received by the communication I/F 207. The processor 203 executes various functional processes of the payment device 2 in accordance with the programs stored in the storage device 206 and/or the ROM 204 and loaded into the RAM 205. The processor 203 controls the communication I/F 209 to transmit to the server 3 a request for confirming whether the acquired tag information is associated with the commodity information.

For example, the storage device 206 is an HDD or a flash memory. The storage device 206 stores software such as an operating system for operating the payment device 2, other necessary application programs, and user information.

The printing device 207 is, for example, a thermal printer. The printing device 207 prints transaction details and the like on a roll-shaped receipt paper in response to completion of the payment by the customer, and issues it as a receipt.

The notification device 208 has a lamp or the like and notifies the state of the payment device 2. During the payment process, the occurrence of a failure or the state of use is notified by switching lighting colors of the lamp.

The communication I/F 209 is an interface circuit for transmitting and receiving information to and from an external device such as the server 3. The information transmitted by the communication I/F 209 includes, for example, a request to confirm whether the tag information acquired by the tag reader 21 is associated with any commodity information. The information received by the communication I/F 207 is, for example, the commodity information associated with the acquired tag information.

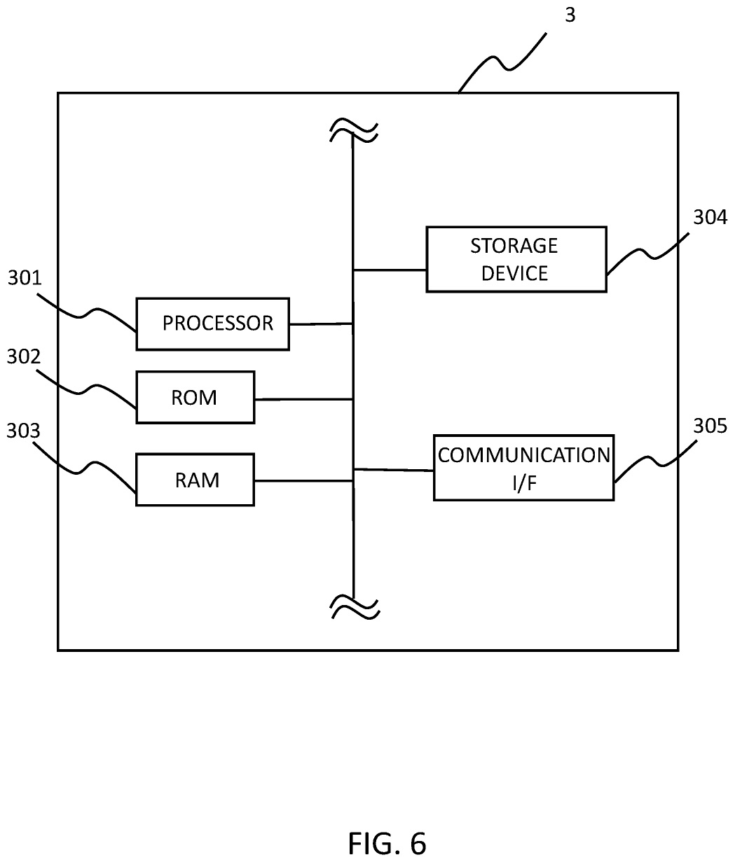

FIG. 6 is a hardware block diagram showing the server 3. The server 3 includes a processor 301, a ROM 302, a RAM 303, a storage device 304, a communication I/F 305, and each component is connected through a bus.

For example, the processor 301 is a CPU that controls the entire operations of the server 3. The ROM 302 stores various programs executed by the processor 301 and various data. The RAM 303 is used as a work area by the processor 301 to load various software programs and various data stored in the ROM 302 and the storage device 304. Examples of the data loaded into the RAM 303 include commodity information received from the commodity registration device 1, tag information associated with the commodity information, and tag information received from the payment device 2. The processor 301 executes various functional processes of the server 3 in accordance with the programs stored in the storage device 304 and/or the ROM 302 and loaded into the RAM 303. The processor 301 controls the communication I/F 305 to transmit the commodity information associated with the tag information to the payment device 2.

For example, the storage device 304 is an HDD or a flash memory. The storage device 304 stores an operating system for operating the server 3, software such as other necessary application programs, and user information. The storage device 304 stores commodity information received from the commodity registration device 1 and tag information associated with the commodity information.

The communication I/F 305 is an interface circuit for transmitting and receiving information to and from an external device such as the commodity registration device 1. The information transmitted by the communication I/F 305 is, for example, commodity information or a response to a request received from the payment device 2. The information received by the communication I/F 305 is, for example, commodity information associated with tag information by the commodity registration device 1, and a request from the payment device 2 to check whether specified tag information is associated with any commodity information.

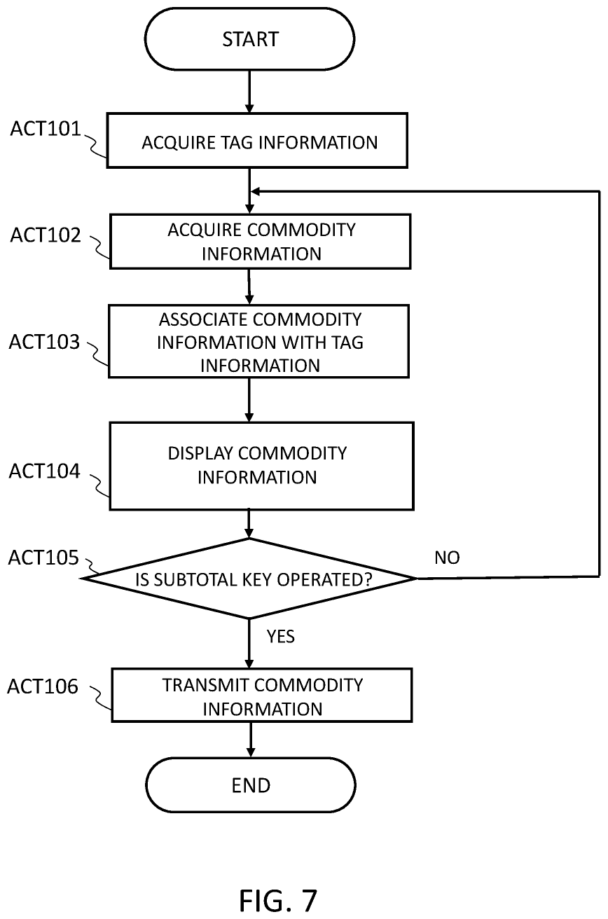

Next, an example of payment processing of the POS system 100 will be described with reference to FIGS. 7 to 9. FIG. 7 is a flowchart of processing performed by the commodity registration device 1.

The processor 106 acquires tag information (ACT101). The tag reader 11 emits electromagnetic waves to an RFID tag attached to a shopping basket placed on the table 10. The processor 106 controls the tag reader 11 to communicate with the tag to acquire tag information. The processor 106 stores the acquired tag information in the RAM 108.

The processor 106 acquires commodity information (ACT102). The processor 106 decodes a commodity code that is attached to a commodity and read through the commodity reader 12, thereby acquiring commodity information. The processor 106 stores the acquired commodity information in the RAM 108.

The processor 106 associates the commodity information with the tag information (ACT103). The processor 106 associates the commodity information and the tag information in the RAM 108.

The processor 106 controls the clerk-side display device 13 and the customer-side display device 14 to display a screen showing the acquired commodity information (ACT104). The processor 106 controls the clerk-side display device 13 and the customer-side display device 14 to update the screen when acquiring another commodity information through the commodity reader 12.

The processor 106 determines whether the subtotal key has been operated (ACT105). When the subtotal key has not been operated (NO in ACT105), the processor 106 returns to the process of ACT102 and repeats the process of ACT102 until YES in order to acquire other commodity information.

When the processor 106 determines that the subtotal key has been operated (YES in ACT105), the processor 106 controls the communication I/F 110 to transmit the commodity information associated with the tag information to the server 3 (ACT106).

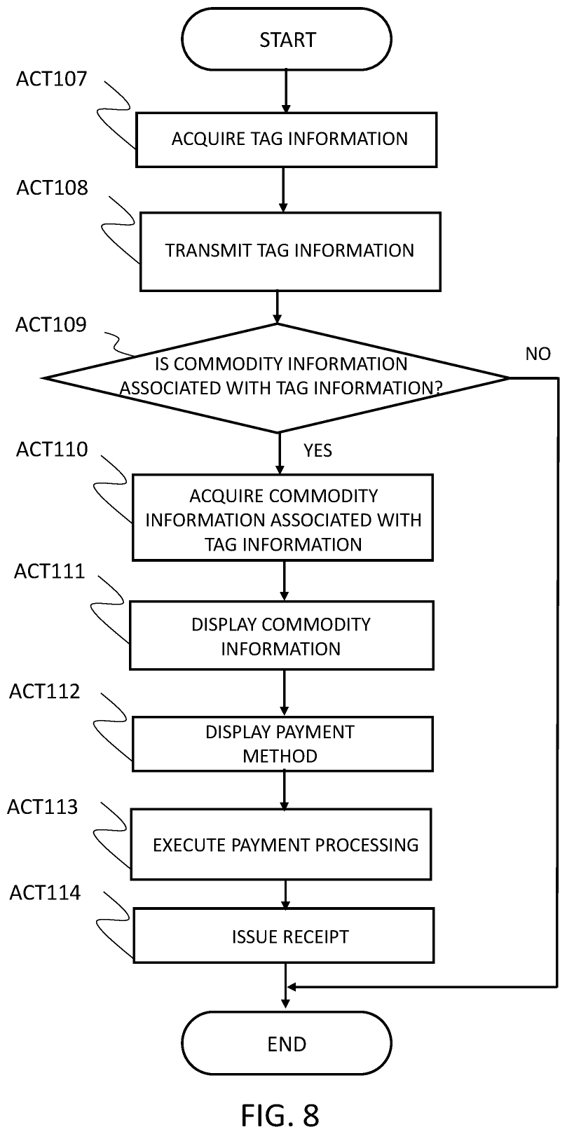

FIG. 8 is a flowchart of processing performed by the payment device 2.

The processor 203 acquires tag information (ACT107). The processor 203 controls the tag reader 21 to emit electromagnetic waves to an RFID tag attached to a shopping basket placed on the table 20 and communicate with the tag to acquire the tag information. The processor 203 stores the acquired tag information in the RAM 205.

The processor 203 controls the communication I/F 209 to transmit the tag information to the server 3 (ACT108). The processor 203 controls the communication I/F 209 to transmit the acquired tag information to the server 3 via the commodity registration device 1 in order to confirm whether the tag information is associated with any commodity information. The processor 203 controls the communication I/F 209 to transmit to the server 3 a request for determining whether the tag information is associated with any commodity information.

The processor 203 determines whether the tag information is associated with any commodity information based on a response from the server 3 (ACT109). If the response does not indicate that the commodity information associated with the acquired tag information exists (NO in ACT109), the processing ends.

If the processor 203 determines that (i.e., the response from the server 3 indicates that) the commodity information associated with the acquired the tag information exists (YES in ACT109), the processor 203 acquires the commodity information associated with the tag information from the server 3 via the commodity registration device 1 (ACT110).

The processor 203 controls the display device 22 to display a screen showing the acquired commodity information (ACT111). For example, the screen shows the commodity name and the price of a commodity corresponding to the acquired commodity information.

The processor 203 controls the display device 22 to display a screen through which a payment method, such as a credit card, cash, or electronic money, can be selected by the customer (ACT112).

The processor 203 executes payment processing according to the selected payment method (ACT113), and issues a receipt showing the details of the transaction and payment (ACT114).

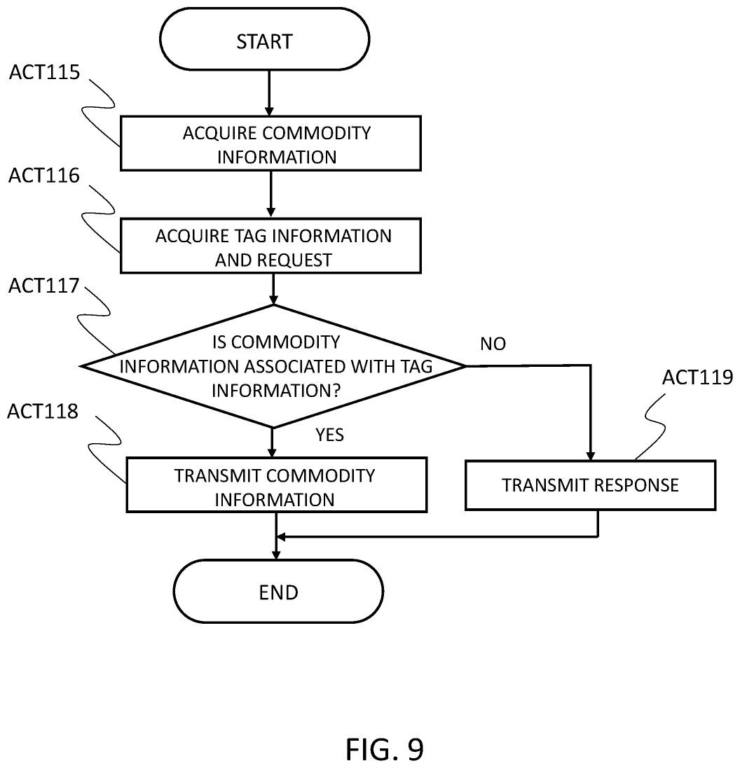

FIG. 9 is a flowchart of processing performed by the server 3.

The processor 301 acquires commodity information from the commodity registration device 1 via the communication I/F 305 (ACT115). The processor 301 acquires the commodity information associated with the tag information from the commodity registration device 1, and stores them in the storage device 304.

The processor 301 acquires the tag information and a request to check whether the tag information is associated with any commodity information from the payment device 2 (ACT116). After receiving the tag information and the request from the payment device 2 via the commodity registration device 1, the processor 301 checks whether any commodity information associated with the received tag information exists (ACT117). When commodity information associated with the received tag information does not exist (NO in ACT117), the processor 301 controls the communication I/F 305 to transmit to the payment device 2 a response indicating that such commodity information does not exist, and ends the processing (ACT119).

On the other hand, when commodity information associated with the received tag information exists (YES in ACT117), the processor 301 controls the communication I/F 305 to transmit the commodity information associated with the received tag information to the payment device 2 (ACT118), and the processor 301 ends the processing.

The POS system 100 described above can efficiently perform payment processing because the POS system 100 allows a customer to simply place on the table 20 of the payment device 2 the shopping basket storing the registered commodities and perform payment processing.

### Second Embodiment

In a second embodiment, the commodity registration device 1 transmits the commodity information associated with tag information to the payment device 2. That is, in the second embodiment, the payment device 2 stores tag information.

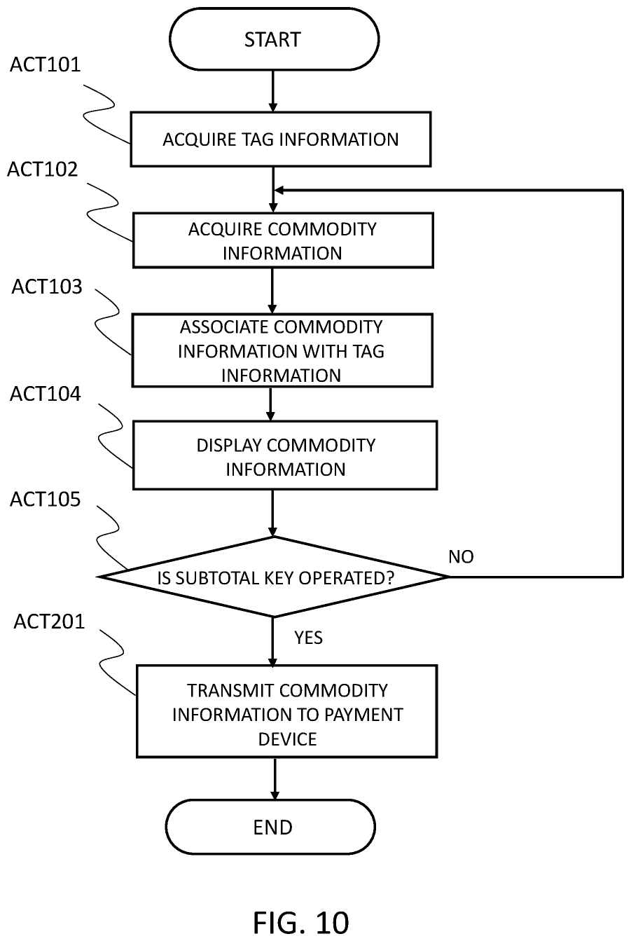

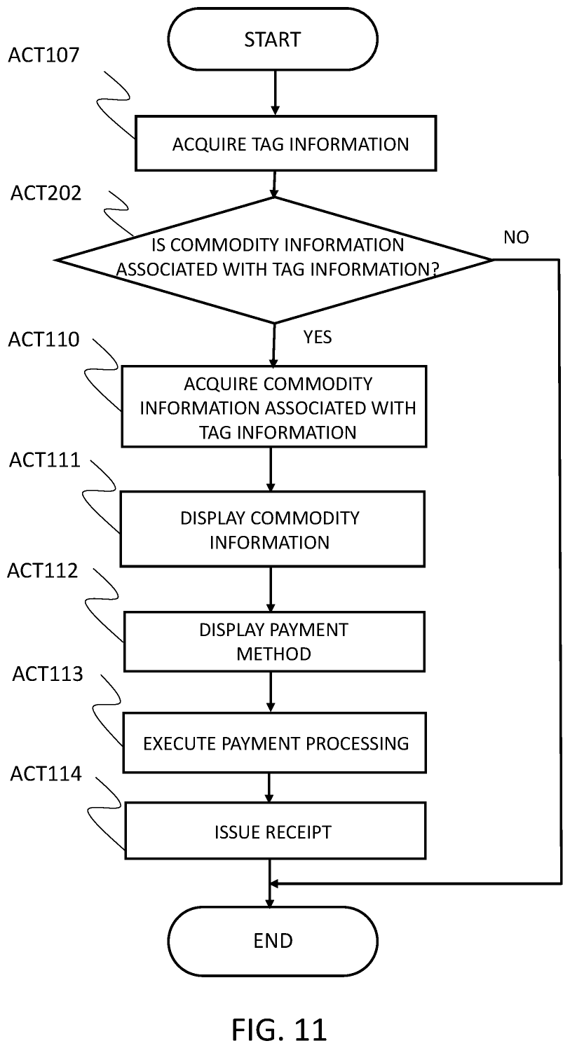

FIG. 10 is a flowchart of processing performed by the commodity registration device 1 according to the second embodiment. FIG. 11 is a flowchart of processing performed by the payment device 2 according to the second embodiment.

As in the first embodiment, the processor 106 acquires tag information and commodity information, associates the commodity information with the tag information, and controls the clerk-side display device 13 and the customer-side display device 14 to display a screen indicating the commodity information (ACT101-ACT104). When the subtotal key is operated (YES in ACT105), the processor 106 controls the communication I/F 110 to transmit the commodity information to the payment device 2 (ACT201).

With reference to FIG. 11, the processor 203 of the payment device 2 acquires the commodity information associated with the tag information from the commodity registration device 1 and stores them in the storage device 206 (ACT107). Thereafter, when a shopping basket is placed on the table 20 and the tag information is acquired via the tag reader 21, the processor 203 determines whether any commodity information associated with the acquired tag information exists in the storage device 206 (ACT202). When the processor 203 determines that commodity information associated with the tag information exists (YES in ACT202), the processor 203 acquires the commodity information associated with the tag information (ACT110). When the processor 203 determines that commodity information associated with the tag information does not exist (NO in ACT202), the processor 203 ends the processing.

Even with such a configuration shown in FIGS. 10 and 11, the POS system 100 can efficiently perform payment processing. In addition, since payment processing is performed without the server 3, the POS system 100 can be installed at low cost. Moreover, processing performance of the POS system 100 can be improved by eliminating the need for network and computer resources for the commodity registration device 1 and the payment device 2 to communicate with the server 3.

### Third Embodiment

In a third embodiment, commodity information stored and registered in a plurality of shopping baskets can be processed in one payment device 2.

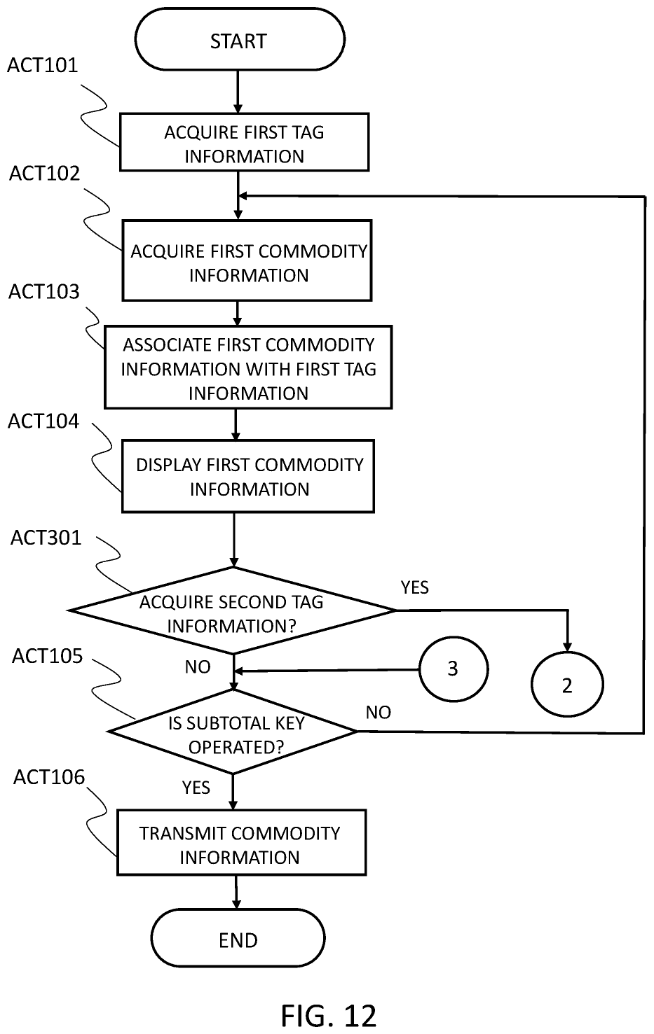

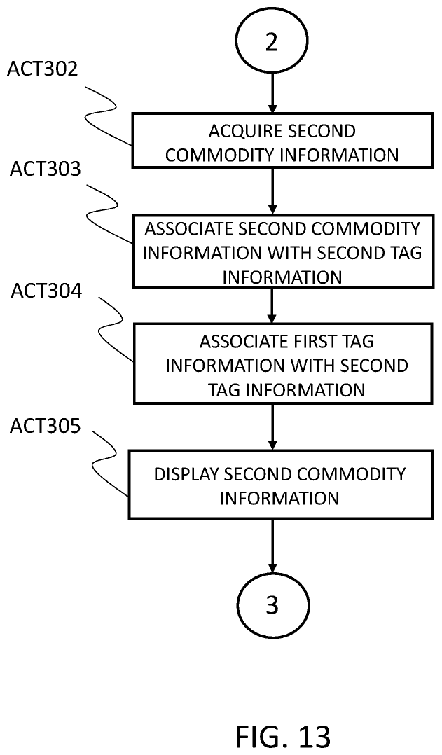

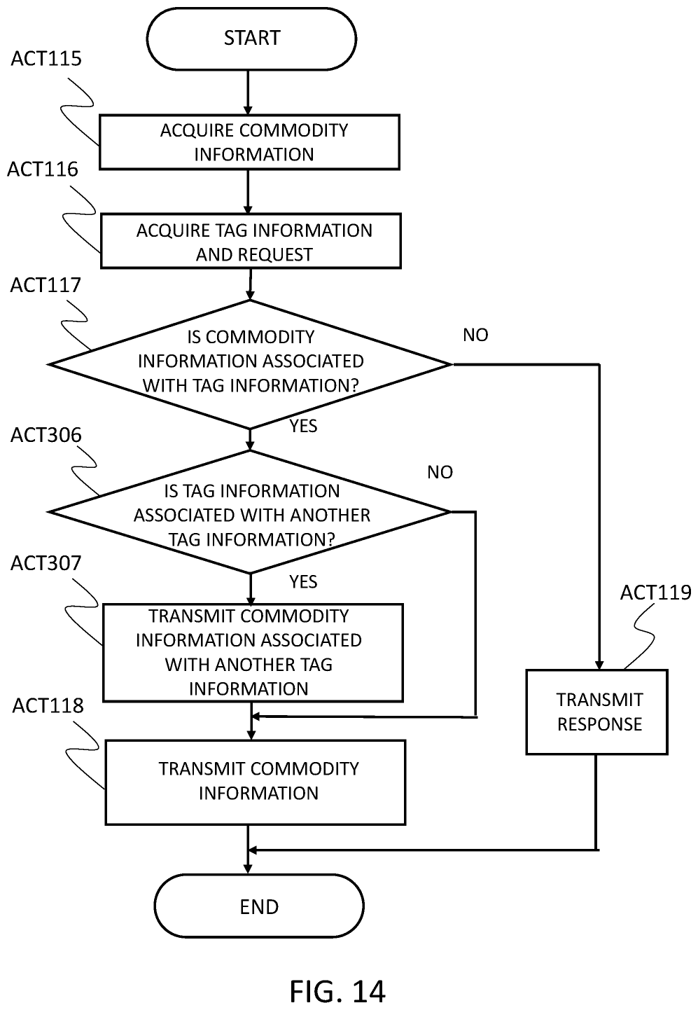

FIG. 12 is a flowchart of processing performed by the commodity registration device 1 according to the third embodiment. FIG. 13 is a flowchart of processing performed by the commodity registration device 1 according to the third embodiment. FIG. 14 is a flowchart showing processing performed by the server 3 according to the third embodiment. In the third embodiment, the payment process using two shopping baskets having first tag and second tag will be described as an example, but the payment process using more than two shopping baskets may be similarly performed. Further, in this third embodiment, the server 3 acquires first commodity information and second commodity information associated with the first tag information will be described.

As in the first embodiment, the processor 106 acquires and associates first tag information and the first commodity information, and controls the clerk-side display device 13 and the customer-side display device 14 to display a screen showing the first commodity information (ACT101-ACT104). When second tag information is acquired before the subtotal key is operated (YES in ACT301), as shown in FIG. 13, the processor 106 acquires second commodity information (ACT302). The processor 106 associates the second tag information with the second commodity information (ACT303). The processor 106 associates the first tag information with the second tag information (ACT304). The processor 106 controls the clerk-side display device 13 and the customer-side display device 14 to update the screen to display the second commodity information (ACT305). Since the first tag information and the second tag information are associated with each other by the processing of ACT304, the second commodity information can be retrieved using the first tag information. After the subtotal key has operated, as shown in FIG. 12, I processor 106 controls the communication I/F 110 to transmit the first commodity information associated with the first tag information and the second commodity information associated with the second tag information to the server 3 (ACT106).

After the commodity registration device 1 transmits the first commodity information and the second commodity information to the server 3, the payment device 2 performs the same processing as in the first embodiment.

With reference to FIG. 14, after acquiring the first and second commodity information from the commodity registration device 1 (ACT115), the processor 301 of the server 3 acquires from the payment device 2 tag information and a request to confirm whether the acquired tag information is associated with any commodity information (ACT117) If the acquired tag information is not associated with any commodity information (NO in ACT117), the processor 301 controls the communication I/F 305 to transmit a response indicating that the tag information is not associated with any commodity information to the payment device 2. If the tag information is associated with commodity information (YES in ACT117), the processor 301 determines whether the first tag information is associated with another, second tag information (ACT306). If the first tag information is not associated with any other (i.e., second) tag information (NO in ACT306), the processor 301 controls the communication I/F 305 to transmit the commodity information associated with the first tag information to the payment device 2 (ACT118). If the first tag information is associated with another (i.e., second) tag information, the processor 301 controls the communication I/F 305 to transmit the commodity information associated with the second tag information to the payment device 2 (ACT307).

Even with such a configuration, the POS system 100 can efficiently perform payment processing. Also, since it is possible to display commodity information associated with other tag information from one tag information, payment processing can be performed more efficiently when a customer carries commodities with two or more shopping baskets.

In the first to third embodiments, the payment device 2 is connected to the server 3 via the commodity registration device 1, but both the commodity registration device 1 and the payment device 2 may be connected to the server 3 via a network.

In the first to third embodiments, an RFID tag is attached to a shopping basket. Alternatively or additionally, a one dimensional code such as a bar code or a code symbol such as a two dimensional code may be attached to a shopping basket or another container such as a shopping bag. In such a case, the payment device 2 has a scanner for optically reading a code to be associated with commodity information instead of tag information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity registration device in a point of sale (POS) system including a self-service payment device configured to perform payment processing on registered commodities, the registration device comprising:
a scanner configured to read commodity information from a code attached to a commodity;
a wireless tag reader configured to read tag information from a wireless tag attached to a container for storing commodities;
a communication interface configured to communicate with the payment device or a server that can communicate with the payment device; and
a processor configured to:
control the tag reader to read first tag information from a first wireless tag attached to a first container,
upon receipt of first commodity information by the scanner, store in a memory the first commodity information in association with the first tag information, and
control the communication interface to transmit, to the payment device or the server, the first commodity information and the first tag information so that the payment device can associate the first commodity information with tag information the payment device has read from a wireless tag attached to a container.

2. The registration device according to claim 1, wherein the processor is further configured to:
control the tag reader to read second tag information from a second wireless tag attached to a second container,
upon receipt of second commodity information by the scanner, store in the memory the second commodity information in association with the second tag information,
store in the memory the second tag information in association with the first tag information, and
control the communication interface to further transmit, to the payment device or the server, the second commodity information and the second tag information so that the payment device can associate the second commodity information with the first or second tag information.

3. The registration device according to claim 1, further comprising:
an input device through which completion of commodity registration processing can be instructed, and
the first commodity information and the first tag information are transmitted after the completion of commodity registration processing is instructed via the input device.

4. The registration device according to claim 3, further comprising:
a first display device facing a first direction, and
a second display device facing a second direction that is different from the first direction, wherein
the first and second display devices are configured to display a screen indicating a commodity corresponding to the first commodity information, and
the input device faces the first direction.

5. The registration device according to claim 4, wherein the scanner faces the first direction.

6. The registration device according to claim 1, further comprising:
a table in which the tag reader is installed and on which the container can be placed.

7. A self-service payment device in a point of sale (POS) system including a commodity registration device for registering commodities, the payment device comprising:
a display device;
a wireless tag reader configured to read tag information from a wireless tag attached to a container for storing commodities; and
a processor configured to:
upon receipt of first tag information from a first wireless tag attached to a first container, determine whether first commodity information that indicates a registered commodity and is associated with the first tag information exists,
upon determining that the first commodity information exists, acquire the first commodity information,
control the display device to display a screen through which a payment method can be selected, and
perform payment processing using the acquired first commodity information and the selected payment method.

8. The payment device according to claim 7, wherein the processor acquires the first commodity information from the registration device.

9. The payment device according to claim 8, wherein the payment device is connected to the registration device.

10. The payment device according to claim 7, further comprising:
a communication interface configured to communicate with a server that can communicate with the registration device, wherein
the processor is further configured to issue a request to the server to determine whether the first commodity information exists.

11. The payment device according to claim 10, wherein the processor acquires the first commodity information from the server via the communication interface.

12. The payment device according to claim 7, further comprising:
a lamp configured to emit lights of different colors, wherein
the processor is further configured to control the lamp to switch the colors depending on conditions of the payment device.

13. The payment device according to claim 7, further comprising:
a table in which the tag reader is installed and on which the container can be placed.

14. A method performed by a point of sale (POS) system including a commodity registration device for registering commodities and a self-service payment device for performing payment processing on the registered commodities, the method comprising:
by the registration device,
reading first tag information from a first wireless tag attached to a first container,
acquiring first commodity information from a code attached to a commodity stored in the first container, and
associating in a memory the first commodity information with the first tag information; and
by the payment device,
upon reading of the first tag information, determining that the first commodity information associated with the first tag information exists,
acquiring the first commodity information associated with the first tag information, and
performing payment processing using the acquired first commodity information.

15. The method according to claim 14, further comprising:
by the registration device, after associating the first commodity information with the first tag information,
reading second tag information from a second wireless tag attached to a second container,
acquiring second commodity information from a code attached to a commodity stored in the second container,
associating in the memory the second commodity information with the second tag information, and
associating in the memory the second tag information with the first tag information.

16. The method according to claim 15, further comprising:
by the payment device, acquiring the second commodity information using either the first tag information or the second tag information, wherein
the payment processing is performed further using the acquired second commodity information.

17. The method according to claim 14, further comprising:
by the registration device,
accepting an input to complete commodity registration processing after associating the first commodity information with the first tag information, and
transmitting the first commodity information and the first tag information to a server in the POS system.

18. The method according to claim 17, further comprising:
by the payment device, transmitting a request to the server to determine that the first commodity information associated with the first tag information exists.

19. The method according to claim 17, further comprising:
by the registration device, displaying a screen on each of first and second display devices facing different directions, the screen indicating the commodity corresponding to the first commodity information.

20. The method according to claim 17, wherein the first tag information is read by a wireless tag reader of each of the registration device and the payment device.
